(19) United States
(12) Patent Application Publication
(10) Pub. No.: US 2022/0363286 A1
(43) Pub. Date: Nov. 17, 2022

(54) VERIFYING AN OBJECT RECOGNITION DETERMINATION PRODUCED BY A PERCEPTION SYSTEM FROM DATA RECEIVED FROM A RANGING SENSOR SYSTEM

(71) Applicant: Toyota Research Institute, Inc., Los Altos, CA (US)

(72) Inventors: Daniel Jackson, Newton, MA (US); Soon Ho Kong, Arlington, MA (US); Nikos Arechiga Gonzalez, San Mateo, CA (US); Anna G. Bryan, Kirkwood, MO (US); Uriel Guajardo, Wharton, TX (US); Jeff Chow, Walnut, CA (US); Geoffrey Litt, Cambridge, MA (US); Joshua Maxwell Pollock, Cambridge, MA (US); Sergio Vale Aguiar Campos, Belo Horizonte (BR)

(73) Assignees: Toyota Research Institute, Inc., Los Altos, CA (US); Massachusetts Institute of Technology, Cambridge, MA (US); Universidade Federal de Minas Gerais, Belo Horizonte (BR)

(21) Appl. No.: 17/321,004

(22) Filed: May 14, 2021

(51) Int. Cl. B60W 60/00; G01S 13/931; G06K 9/00

(52) U.S. Cl. CPC B60W 60/001; G01S 13/931; G06K 9/00791; B60W 2420/52; G01S 2013/9321; G01S 2013/9325

(57) ABSTRACT

An object recognition determination produced by a perception system from data received from a ranging sensor system can be verified. A certificate can be produced that includes data for points of readings from the ranging sensor system. The points can have been segmented, by the perception system, into point sets that correspond to objects in an environment of a cyber-physical system. The certificate can also include lists of pairs of points in a point set and a velocity of the point set. A test of information in the certificate can be performed. Based on a result of the test: a rectification can be made to the perception system or the ranging sensor system or a communication can be transmitted to a control signal production module configured to produce, in response to the communication, a control signal to be transmitted to an actuator system configured to control the cyber-physical system.

### TECHNICAL FIELD

The disclosed technologies are directed to verifying an object recognition determination produced by a perception system, of a cyber-physical system, from data received from a ranging sensor system of the cyber-physical system.

### BACKGROUND

A cyber-physical system can be a computer system configured to monitor and/or control a mechanism in a manner in which one or more interactions between the computer system and one or more physical elements of the mechanism can account for different behavioral modalities and/or different contexts. Examples of a cyber-physical system can include a medical monitoring system, an electrical grid monitoring system, an industrial control system, a robotics system, an autonomous vehicle, or the like. Often, a cyber-physical system can include one or more of a sensor system, a perception system, a controller system, an actuator system, or the like. For example, the sensor system can include technologies through which the cyber-physical system can detect objects in an environment of the cyber-physical system. For example, the perception system can perform one or more functions on data from the sensor system to produce information that facilitates a better understanding of the environment of the cyber-physical system. Such functions can include, for example, localization of the cyber-physical system, determination of velocities of the objects in the environment of the cyber-physical system, production of an object recognition determination of the objects in the environment of the cyber-physical system, or the like. Localization can include functions to determine a position of the cyber-physical system with a margin of error, for example, of less than a decimeter. Production of the object recognition determination can include, for example, an addition of labels to data for the objects. For example, the controller system can use the information from the perception system to determine one or more actions to be performed by the one or more physical elements of the mechanism. For example, the actuator system can receive one or more control signals from the controller system and cause the one or more actions to be performed by the one or more physical elements of the mechanism.

### SUMMARY

In an embodiment, a system for verifying an object recognition determination produced by a perception system from data received from a ranging sensor system can include a processor and a memory. The memory can store a controller subsystem module, a runtime monitoring module, and a control signal production module. The controller subsystem module can include instructions that when executed by the processor cause the processor to produce a certificate. The certificate can include data for points of readings from the ranging sensor system. The points can have been segmented, by the perception system, into point sets that correspond to objects in an environment of a cyber-physical system. The certificate can also include lists of pairs of points in a point set and a velocity of the point set. The runtime monitoring module can include instructions that when executed by the processor cause the processor to perform a test of information in the certificate. The runtime monitoring module can include instructions that when executed by the processor cause the processor to cause, based on a result of the test, one or more of: (1) a rectification to be made to one or more of the perception system or the ranging sensor system or (2) a communication to be transmitted to a control signal production module. The control signal production module can include instructions that when executed by the processor cause the processor to produce, in response to the communication, a control signal to be transmitted to an actuator system configured to control an operation of the cyber-physical system.

In another embodiment, a method for verifying an object recognition determination produced by a perception system from data received from a ranging sensor system can include producing, by a processor, a certificate. The certificate can include data for points of readings from the ranging sensor system. The points can have been segmented, by the perception system, into point sets that correspond to objects in an environment of a cyber-physical system. The certificate can also include lists of pairs of points in a point set and a velocity of the point set. The method can also include performing, by the processor, a test of information in the certificate. The method can also include causing, by the processor and based on a result of the test, one or more of: (1) a rectification to be made to one or more of the perception system or the ranging sensor system or (2) a communication to be transmitted to a control signal production module configured to produce, in response to the communication, a control signal to be transmitted to an actuator system configured to control an operation of the cyber-physical system.

In another embodiment, a non-transitory computer-readable medium for verifying an object recognition determination produced by a perception system from data received from a ranging sensor system can include instructions that when executed by one or more processors cause the one or more processors to produce a certificate. The certificate can include data for points of readings from the ranging sensor system. The points can have been segmented, by the perception system, into point sets that correspond to objects in an environment of a cyber-physical system. The certificate can also include lists of pairs of points in a point set and a velocity of the point set. The non-transitory computer-readable medium can include instructions that when executed by the one or more processors cause the one or more processors to perform a test of information in the certificate. The non-transitory computer-readable medium can include instructions that when executed by the one or more processors cause the one or more processors to cause, based on a result of the test, one or more of: (1) a rectification to be made to one or more of the perception system or the ranging sensor system or (2) a communication to be transmitted to a control signal production module configured to produce, in response to the communication, a control signal to be transmitted to an actuator system configured to control an operation of the cyber-physical system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for verifying an object recognition determination produced by a perception system, of a cyber-physical system, from data received from a ranging sensor system of the cyber-physical system, according to the disclosed technologies.

FIG. 2 includes a diagram that illustrates an example in which the cyber-physical system, according to the disclosed technologies, is included in a vehicle.

FIG. 3 includes a block diagram that illustrates an example of a system for verifying the object recognition determination produced by the perception system, of the cyber-physical system, from the data received from the ranging sensor system of the cyber-physical system, according to the disclosed technologies.

FIG. 4 includes a diagram that illustrates an example of points of readings, from a lidar device, of the environment, according to the disclosed technologies.

FIGS. 5A and 5B include a set of tables that illustrate examples of data for the points, according to the disclosed technologies.

FIG. 6 includes a diagram that illustrates an example of an image that is a fusion of an image of the points, from the lidar device, and an image of the environment produced by a camera, according to the disclosed technologies.

FIG. 7 includes a set of tables that illustrate examples of information included in a certificate produced by a controller subsystem module, according to the disclosed technologies.

FIGS. 8A and 8B are a flow diagram that illustrates an example of a method that is associated with verifying the object recognition determination produced by the perception system, of the cyber-physical system, from the data received from the ranging sensor system of the cyber-physical system, according to the disclosed technologies.

FIG. 9 includes a block diagram that illustrates an example of elements disposed on a vehicle, according to the disclosed technologies.

### DETAILED DESCRIPTION

An error associated with an action performed by a physical element of a mechanism in a cyber-physical system can often be due to an error produced by a perception system of the cyber-physical system. For example, one study of nearly 160,000 disengagements of automated driving systems of autonomous vehicles found that: (1) 21 percent of these disengagements could be directly attributed to errors produced by perception systems of the autonomous vehicles and (2) another 53 percent of these disengagements could be indirectly attributed to errors produced by the perception systems of the autonomous vehicles. For example, poor and/or unexpected weather and/or road conditions can cause a perception system to produce an error and an error produced by the perception system can cause, in turn, a controller system of an autonomous vehicle to produce an error.

The disclosed technologies are directed to verifying an object recognition determination produced by a perception system, of a cyber-physical system, from data received from a ranging sensor system of the cyber-physical system. For example, the cyber-physical system can include a medical monitoring system, an electrical grid monitoring system, an industrial control system, a robotics system, an autonomous vehicle, or the like. Data for points of readings of an environment of the cyber-physical system can be received from the ranging sensor system. The ranging sensor system can include, for example, one or more of a lidar device, a radar device, an ultrasonic ranging device, an infrared ranging device, or the like. The points of the readings can be segmented, by the perception system, into point sets that correspond to objects in the environment of the cyber-physical system. That is, because each point set can correspond to an object, a set of point sets produced by the perception system can be an object recognition determination produced by the perception system. A certificate can be produced. The certificate can include the data for the points of the readings. The certificate can also include, for the point sets: (1) lists of pairs of points in a point set and (2) a velocity of the point set. For each point set, a corresponding list of pairs of points in the point set can be referred to as a traversal. A test of information in the certificate can be performed. Based on a result of the test, one or more of: (1) a rectification can be caused to be made to the perception system, the ranging sensor system, or both or (2) a communication can be caused to be transmitted to a control signal production module configured to produce, in response to the communication, a control signal to be transmitted to an actuator system configured to control an operation of the cyber-physical system.

For example, in one test, a difference between: (1) a distance between a first point, of a pair of points from a list of pairs of points in a point set, and the cyber-physical system and (2) a distance between a second point, of the pair of points from the list of pairs of points in the point set, and the cyber-physical system, can be determined. A relationship between the difference and a threshold difference can be determined. If the difference is greater than the threshold difference, then an object that corresponds to the first point may be different from an object that corresponds to the second point even though segmentation of the points by the perception system caused a single point set to include both the first point and the second point.

Additionally or alternatively, for example, in another test, a difference between a velocity of a point in a point set and the velocity of the point set can be determined. A relationship between the difference and a threshold difference can be determined. If the difference is greater than the threshold difference, then an object that corresponds to the point may be different from an object that corresponds to at least one other point in the point set even though segmentation of the points by the perception system caused a single point set to include both the point and the at least one other point.

Additionally or alternatively, for example, in even another test, an image of the points of the readings can be divided into a grid and an ascertainment can be made, for a cell of the grid, of an existence of a point within the cell. Such an ascertainment can be made for each cell of the grid. A lack of an existence of a point within a cell may be indicative of a situation, with one or more of the perception system or the ranging sensor system, that needs rectification.

Additionally or alternatively, for example, in yet another test, the certificate can include a label that identifies a point, of the points of the readings, with respect to being associated with a ground plane. For example, the ground plane can include a road surface, a sidewalk, or the like. A difference between: (1) a height of a first point of a set of points associated with the ground plane and (2) a height of a second point of the set of points associated with the ground plane can be determined. A relationship between the difference and a threshold difference can be determined. If the difference is greater than the threshold difference, then either the first point or the second point may be erroneously associated with the ground plane.

Additionally or alternatively, for example, in still another test, a determination can be made, based on the velocity of the point set and a velocity of the cyber-physical system, that an object that corresponds to the point set may not be outside of a stopping distance between the object and the cyber-physical system. For example, if the cyber-physical system is an autonomous vehicle, then the communication transmitted to the control signal production module can cause the control signal production module to produce, in response to the communication, a control signal to be transmitted to the actuator system to cause an operation of the autonomous vehicle in response to the object not being outside of the stopping distance between the object and the autonomous vehicle.

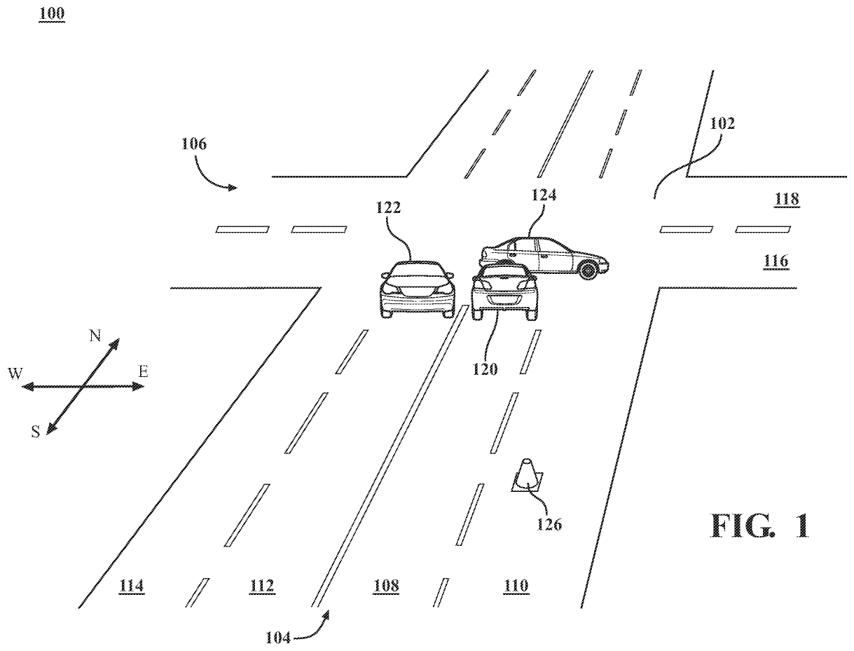

FIG. 1 includes a diagram that illustrates an example of an environment 100 for verifying an object recognition determination produced by a perception system, of a cyber-physical system, from data received from a ranging sensor system of the cyber-physical system, according to the disclosed technologies. For example, the environment 100 can include an intersection 102 of a first road 104 and a second road 106. For example, the first road 104 can be disposed along a line of longitude and the second road 106 can be disposed along a line of latitude. For example, the first road 104 can include, for northbound traffic, a left lane 108 and a right lane 110. For example, the first road 104 can include, for southbound traffic, a left lane 112 and a right lane 114. For example, the second road 106 can include, for eastbound traffic, a lane 116. For example, the second road 106 can include, for westbound traffic, a lane 118. For example, the environment 100 can include a first vehicle 120, a second vehicle 122, and a third vehicle 124. For example the first vehicle 120 can be stopped just south of the intersection 102 in in the left lane 108 for northbound traffic for the first road 104. For example, the second vehicle 122 can be moving at 50 kilometers per hour just south of the intersection 102 in the left lane 112 for southbound traffic for the first road 104. For example, the third vehicle 124 can be moving at 50 kilometers per hour in the intersection 102 in the lane 116 for eastbound traffic for the second road 106. For example, from a point of view of the environment 100, a portion of the third vehicle 124 can be occluded by the first vehicle 120. For example, the environment 100 can include a traffic cone 126. For example, the traffic cone 126 can be in the right lane 110 for northbound traffic for the first road 104.

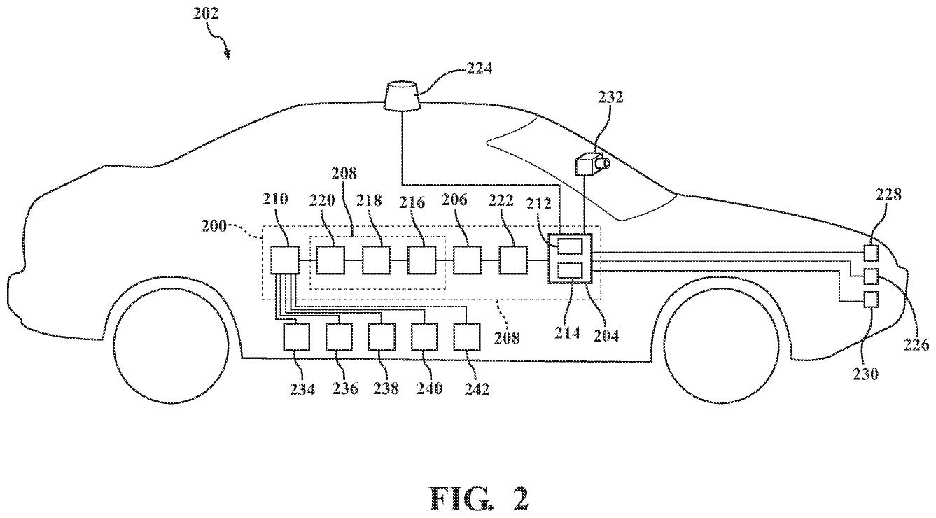

FIG. 2 includes a diagram that illustrates an example in which a cyber-physical system 200, according to the disclosed technologies, is included in a vehicle 202. The cyber-physical system 200 can include, for example, a sensor system 204, a perception system 206, a controller system 208, and an actuator system 210. The sensor system 204 can include, for example, a ranging sensor system 212 and an image sensor system 214. The controller system 208 can include, for example, a controller subsystem module 216, a runtime monitoring module 218, and a control signal production module 220. Additionally, for example, the cyber-physical system 200 can include an encryption system 222. The vehicle 202 can include, for example, one or more of a lidar device 224, a radar device 226, an ultrasonic device 228, an infrared device 230, a camera 232, or the like. For example, the ultrasonic device 228 can be an ultrasonic ranging device, an ultrasonic imaging device, or both. For example, the infrared device 230 can be an infrared ranging device, an infrared imaging device, or both. For example, the camera 232 can be one or more of a color camera, a stereoscopic camera, a video camera, a digital video camera, or the like. The vehicle 202 can include, for example, one or more wheel steering actuators 234, one or more brake actuators 236, a clutch actuator 238, a throttle position actuator 240 (e.g., if the vehicle 202 is propelled by an internal combustion engine), a current control actuator 242 (e.g., if the vehicle 202 is propelled by an electric motor), or the like.

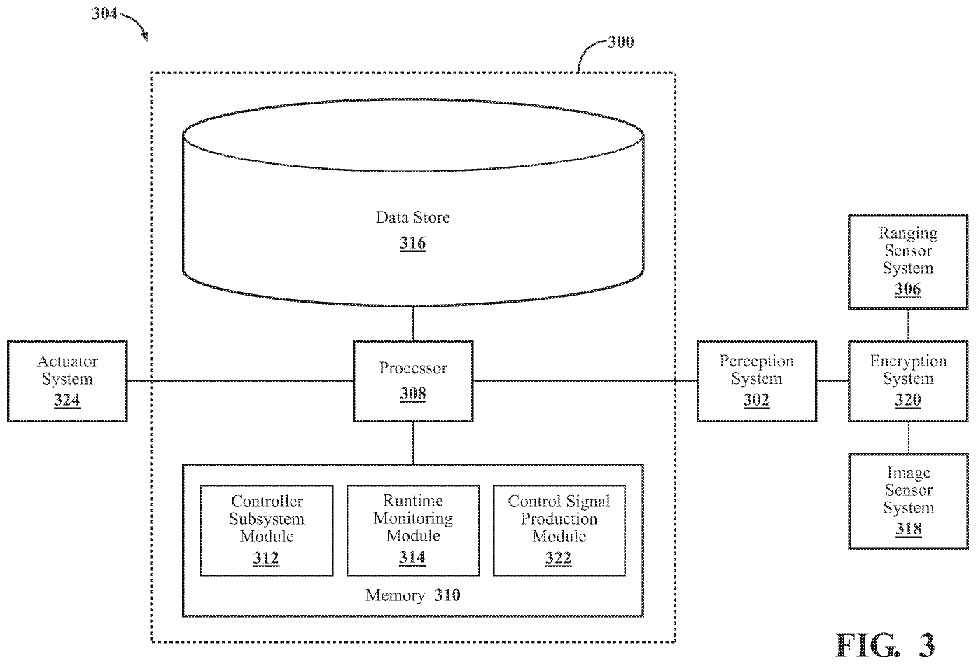

FIG. 3 includes a block diagram that illustrates an example of a system 300 for verifying the object recognition determination produced by a perception system 302, of a cyber-physical system 304, from data received from a ranging sensor system 306 of the cyber-physical system 304, according to the disclosed technologies. The system 300 can include, for example, a processor 308 and a memory 310. The memory 310 can be communicably coupled to the processor 308. For example, the memory 310 can store a controller subsystem module 312, a runtime monitoring module 314, and a control signal production module 322. The controller subsystem module 312 can include instructions that function to control the processor 308 to produce a certificate. The certificate can include, for example, data for points of readings from the ranging sensor system 306. Additionally, for example, the system 300 can include a data store 316. The data store 316 can be communicably coupled to the processor 308. The data store 316 can be configured to store the data for the points of the readings. The points can have been segmented, by the perception system 302, into point sets that correspond to objects in an environment of the cyber-physical system 304. The certificate can also include, for example: (1) lists of pairs of points in a point set and (2) a velocity of the point set. For each point set, a corresponding list of pairs of points in the point set can be referred to as a traversal. The runtime monitoring module 314 can include instructions that function to control the processor 308 to perform a test of information in the certificate. The runtime monitoring module 314 can include instructions that function to control the processor 308 to cause, based on a result of the test, one or more of: (1) a rectification to be made to the perception system 302, the ranging sensor system 306, or both or (2) a communication to be transmitted to the control signal production module 322. The control signal production module 322 can include instructions that function to control the processor 308 to produce, in response to the communication, a control signal to be transmitted to an actuator system 324 configured to control an operation of the cyber-physical system 304. For example, the rectification can include an adjustment to an operation of the perception system 302, the ranging sensor system 306, or both. For example, the communication can include information about the result of the test. For example, the information about the result of the test can include an indication that an output of the perception system 302, the ranging sensor system 306, or both is unreliable.

For example, the cyber-physical system 304 can include a medical monitoring system, an electrical grid monitoring system, an industrial control system, a robotics system, or the like. For example, the robotics system can include an autonomous vehicle.

For example, the ranging sensor system 306 can include one or more of a lidar device, a radar device, an ultrasonic ranging device, an infrared ranging device, or the like.

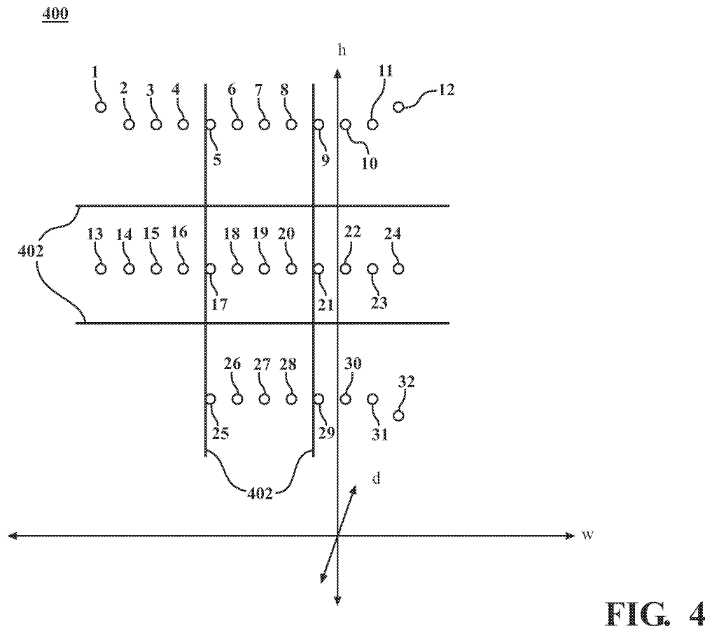

FIG. 4 includes a diagram that illustrates an example of points 400 of readings, from the lidar device 224, of the environment 100, according to the disclosed technologies. The points 400 can include, for example, Point #1 through Point #32. For example, the points 400 can be arrayed in a Cartesian coordinate system that has an origin at the lidar device 224, a width (w) axis, a height (h) axis, and a depth (d) axis.

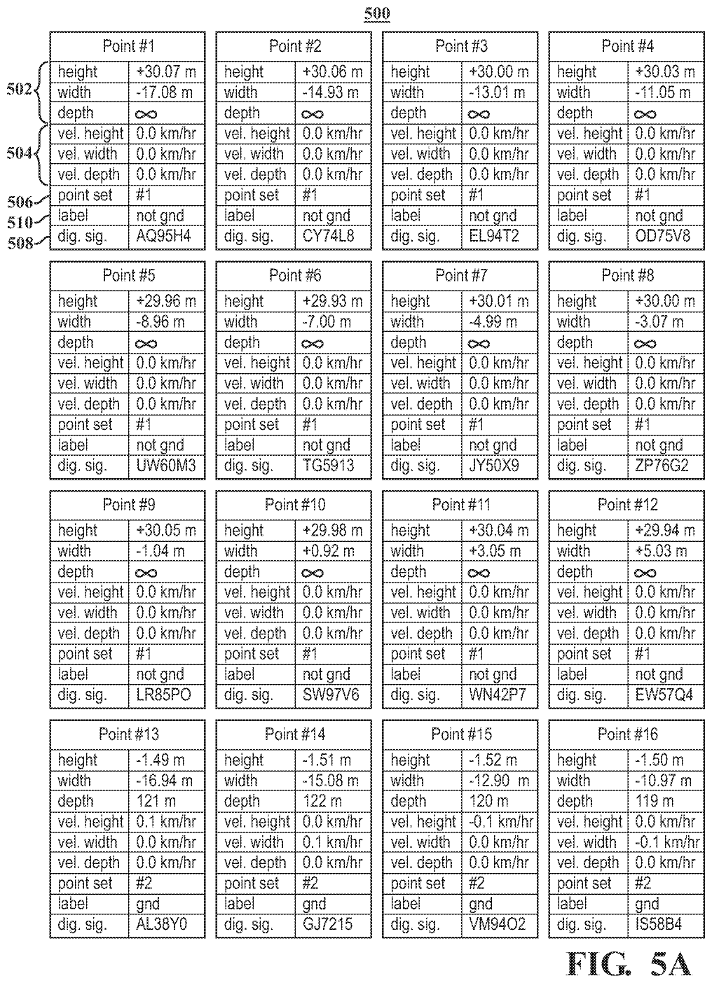

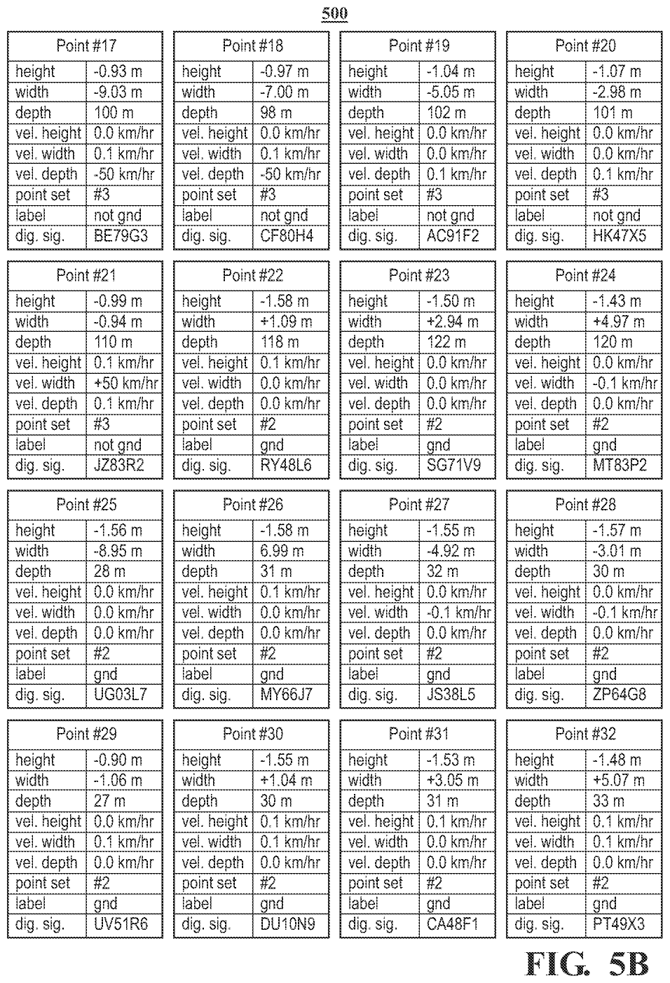

FIGS. 5A and 5B include a set of tables 500 that illustrate examples of the data for the points 400, according to the disclosed technologies. For example, the set of tables 500 can include a table for each of Point #1 through Point #32. For example, data for a point, of the points 400, can include a location 502 of the point. For example, the location can be expressed with respect to coordinates on the width (w) axis, the height (h) axis, and the depth (d) axis.

Additionally, for example, the data for the point can include a velocity 504 of the point. For example, the velocity can be expressed as a rate of motion with respect to the width (w) axis, the height (h) axis, and the depth (d) axis. With reference to FIG. 3, for example, the ranging sensor system 306 can include a Doppler device configured to determine the velocity of the point. Additionally or alternatively, for example, the perception system 302 can be configured to calculate the velocity of the point.

With reference to FIGS. 3 and 4, as described above, the points 400 can be segmented, by the perception system 302, into the point sets that correspond to the objects in the environment of the cyber-physical system 304. Because each point set can correspond to an object, a set of point sets produced by the perception system 302 can be an object recognition determination produced by the perception system 302. For example, the perception system 302 can be configured to execute a function having as arguments the data for the points 400. The function can segment the points 400 into the point sets. Additionally or alternatively, for example, the perception system 302 can be configured to receive, from an image sensor system 318, an image of the environment of the cyber-physical system 304. For example, the image sensor system 318 can include one or more of a camera, an ultrasonic imaging device, an infrared imaging device, or the like. For example, the camera can include one or more of a color camera, a stereoscopic camera, a video camera, a digital video camera, or the like. The perception system 302 can be configured to process the data for the points 400 and the image to segment the points 400 into the point sets.

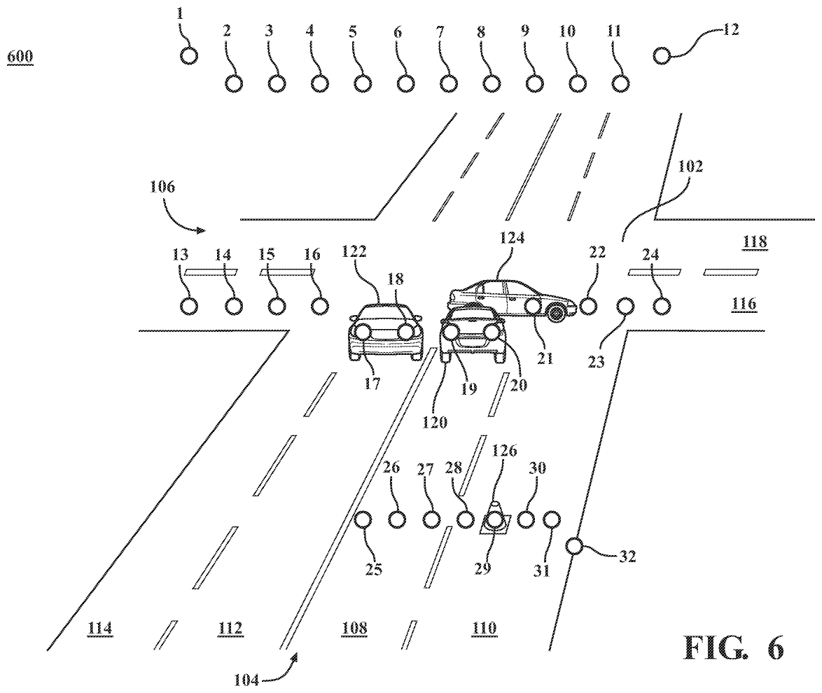

FIG. 6 includes a diagram that illustrates an example of an image 600 that is a fusion of an image of the points 400, from the lidar device 224, and an image of the environment 100 produced by the camera 232, according to the disclosed technologies. With reference to FIGS. 1, 2, 4, 5A, 5B, and 6, for example: (1) Point #1 through Point #12 can correspond to the sky, (2) Point #13 through Point #16 and Point #22 through Point #24 can correspond to a ground plane (e.g., a road surface, a sidewalk, etc.) at a depth of about 120 meters from the lidar device 224, (3) Point #17 and Point #18 can correspond to the second vehicle 122, (4) Point #19 and Point #20 can correspond to the first vehicle 120, (5) Point #21 can correspond to the third vehicle 124, (6) Point #25 through Point #28 and Point #30 through Point #32 can correspond to a ground plane (e.g., a road surface, a sidewalk, etc.) at a depth of about 30 meters from the lidar device 224, and (7) Point #29 can correspond to the traffic cone 126.

With reference to FIGS. 5A and 5B, additionally, for example, the data for the point can include an identification 506 of the point set in which the point, following segmentation of the points 400 by the perception system 302, is an element. For example: (1) Point #1 through Point #12 can correspond to Point Set #1, (2) Point #13 through Point #16 and Point #22 through Point #30 can correspond to Point Set #2, and (3) Point #17 through Point #21 can correspond to Point Set #3. Thus, with reference to FIGS. 1, 3, 4, 5B, and 6, for example, the perception system 302 produced errors in the segmentation of the points 400. Specifically, although: (1) Point #17 and Point #18 correspond to the second vehicle 122, (2) Point #19 and Point #20 correspond to the first vehicle 120, and (3) Point #21 corresponds to the third vehicle 124, the perception system 302 included all of these points as elements of Point Set #3. Additionally, specifically, although Point #29 corresponds to the traffic cone 126, the perception system 302 included this point in Point Set #2.

With reference to FIG. 3, as described above, the controller subsystem module 312 can produce a certificate. The certificate can include, for example: (1) the data for the points 400, (2) lists of pairs of points in a point set, and (3) a velocity of the point set. The set of tables 500 includes a table for the data for each of Point #1 through Point #32. Thus, the certificate can include, for example, the set of tables 500.

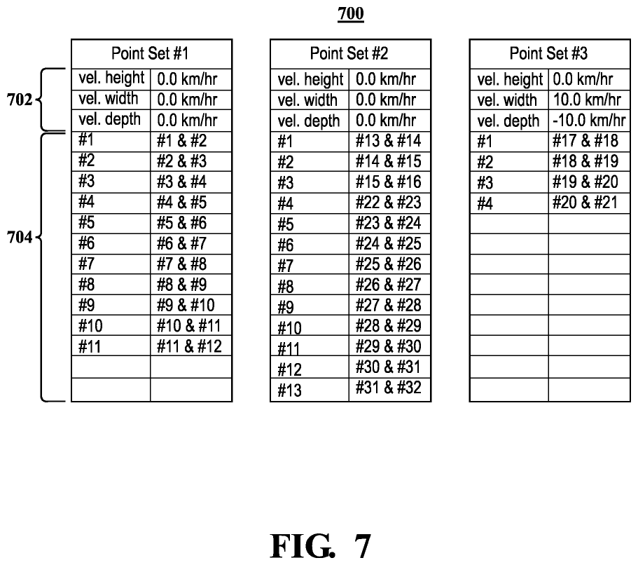

FIG. 7 includes a set of tables 700 that illustrate examples of additional information included in the certificate produced by the controller subsystem module 312, according to the disclosed technologies. For example, the set of tables 700 can include a table for each of Point Set #1 through Point Set #3. For example, additional information included in the certificate can include: (1) a velocity 702 of the point set and (2) a list 704 of pairs of points in the point set. For each point set, the list 704 can be referred to as a traversal.

Returning to FIG. 3, additionally, for example, the runtime monitoring module 314 can further include instructions that function to control the processor 308 to authenticate the data for the points 400.

With reference to FIGS. 5A and 5B, for example, the data for the points 400 can include a digital signature 508. Returning to FIG. 3, for example, the instructions to authenticate the data for the points 400 can include instructions that function to control the processor 308 to use the digital signature to verify an authenticity of the data for the points 400. For example, the ranging sensor system 306 can be configured to produce the digital signature. For example, the range sensor system 306 can be a secure ranging sensor system. Additionally or alternatively, for example, an encryption system 320 can be configured to: (1) receive, from the ranging sensor system 306, the data for the points 400, (2) produce the digital signature, and (3) transmit, to the perception system 302, the data for the points 400 with the digital signature.

Additionally or alternatively, for example, the instructions to authenticate the data for the points 400 can include instructions that function to control the processor 308 to cause communications to be exchanged between the runtime monitoring module 314 and the ranging sensor system 306 to verify an authenticity of the data for the points 400.

As described above, the runtime monitoring module 314 can perform a test of information in the certificate.

For example, a first implementation of the test can include: (1) determining a difference between: (a) a distance between a first point, of a pair of points from a list of the pairs of points in the point set, and the cyber-physical system 304 and (b) a distance between a second point, of the pair of points from the list of pairs of points in the point set, and the cyber-physical system 304 and (2) determining a relationship between an absolute value of the difference and a threshold difference.

With reference to FIGS. 3, 5B, 6, and 7, for example, if: (1) the point set is Point Set #3, (2) the pair of points is Pair #4, Point #20 and Point #21, and (3) the threshold difference is 5 meters, then: (1) the difference between: (a) 101 meters and (b) 110 meters is 9 meters and (2) the relationship between the absolute value of the difference (9 meters) and the threshold difference (5 meters) is that the difference is greater than the threshold difference. Having the difference be greater than the threshold difference may be indicative that the object that corresponds to Point #20 is different from the object that corresponds to Point #21 even though the perception system 302 included both of these points as elements of Point Set #3. Indeed, in reality: (1) Point #20 corresponds to the first vehicle 120 and (2) Point #21 corresponds to the third vehicle 124.

Additionally or alternatively, for example, a second implementation of the test can include: (1) determining a difference between: (a) a velocity of a point in the point set and (b) the velocity of the point set and (2) determining a relationship between an absolute value of the difference and a threshold difference.

With reference to FIGS. 3, 5B, 6, and 7, for example, if: (1) the point set is Point Set #3, (2) the point is Point #18, and (3) the threshold difference is 0.1 kilometer per hour, then: (1) the difference between: (a) −50 kilometers per hour and (b) −10 kilometers per hour is −40 kilometers per hour and (2) the relationship between the absolute value of the difference (40 kilometers per hour) and the threshold difference (0.1 kilometer per hour) is that the absolute value of the difference is greater than the threshold difference. Having the absolute value of the difference be greater than the threshold difference may be indicative that the object that corresponds to Point #18 is different from the object that corresponds to at least one other point in Point Set #3 even though the perception system 302 caused Point Set #3 to include both Point #18 and the at least one other point. Indeed, in reality: (1) Point #18, included in Point Set #3, corresponds to the second vehicle 122, (2) Point #19 and Point #20, included in Point Set #3, correspond to the first vehicle 120, and (3) Point #21, included in Point Set #3, corresponds to the third vehicle 124.

Returning to FIG. 3, additionally or alternatively, for example, the runtime monitoring module 314 can further include instructions that function to control the processor 308 to divide an image of the points 400 into a grid. With reference to FIG. 4, for example, the image of the points 400 can be divided into a grid 402. For example, the grid 402 can be two-dimensional and can have a first axis parallel to the width (w) axis and a second axis parallel to the height (h) axis. For example, the grid 402 can include nine cells arranged in three rows and three columns.

Additionally or alternatively, for example, a third implementation of the test can include ascertaining, for a cell of the grid 402, an existence of a point within the cell.

For example, there is a lack of an existence of any point in the lowest, leftmost cell of the grid 402. The lack of the existence of any point in the lowest, leftmost cell of the grid 402 may be indicative of a situation, with one or more of the perception system 302 or the ranging sensor system 306, that needs rectification.

Additionally or alternatively, for example, the certificate can include a label that identifies a point, of the points 400, with respect to being associated with a ground plane. With reference to FIGS. 5A and 5B, for example, the data for the point can include a label 510 that identifies the point with respect to being associated with the ground plane. For example, the label that identifies the point can include a first label (not illustrated) and a second label (not illustrated). For example: (1) the first label can identify the point with respect to being associated with a road surface and (2) the second label can identify the point with respect to being associated with a sidewalk. Returning to FIG. 3, for example, the perception system 302 can be configured to: (1) identify the point as being associated with the ground plane and (2) add, to the data for the point, the label.

Additionally or alternatively, for example, a fourth implementation of the test can include: (1) determining a difference between: (a) a height of a first point of a set of points associated with the ground plane and (b) a height of a second point of the set of points associated with the ground plane and (2) determining a relationship between an absolute value of the difference and a threshold difference.

With reference to FIGS. 1, 3, 4, 5B, and 6, for example, if: (1) the first point is Point #29, (2) the second point is Point #30, and (3) the threshold difference is 15 centimeters, then: (1) the difference between: (a) −0.90 meters and (b) −1.55 meters is −0.65 meters and (2) the relationship between the absolute value of the difference (65 centimeters) and the threshold difference (15 centimeters) is that the absolute value of the difference is greater than the threshold difference. Having the absolute value of the difference be greater than the threshold difference may be indicative that either Point #29 or Point #30 has been erroneously associated with the ground plane. Indeed, in reality, Point #29 corresponds to the traffic cone 126.

Additionally or alternatively, for example, a fifth implementation of the test can include determining, based on the velocity of the point set and a velocity of the cyber-physical system 304, that an object that corresponds to the point set is outside of a stopping distance between the object and the cyber-physical system 304.

With reference to FIGS. 1, 3, 4, 5B, 6, and 7, for example, because, based on a result of the fourth implementation of the test described above, Point #29 can be determined to correspond to the traffic cone 126 and not to correspond to the ground plane, determining the stopping distance between the traffic cone 126 and the cyber-physical system 304 can be desired. For example, if: (1) the point set is Point Set #2, (2) the velocity of Point Set #2 is 0.0 kilometers per hour, (3) the velocity of the cyber-physical system 304 is 65 kilometers per hour, (4) the stopping distance between the traffic cone 126 (Point #29) and the cyber-physical system 304 is 36 meters, and (5) Point #29 (the traffic cone 126) is 27 meters from the cyber-physical system 304, then Point #29 (the traffic cone 126) is not outside of the stopping distance between the traffic cone 126 (Point #29) and the cyber-physical system 304.

With reference to FIGS. 1 and 3, for example, based on a result of the fifth implementation of the test described above being that the traffic cone 126 is not outside of the stopping distance between the traffic cone 126 and the cyber-physical system 304, the communication transmitted to the control signal production module 322 can include this information and the control signal transmitted to the actuator system 324 can cause the cyber-physical system 304 to change from moving in the right lane 110 for northbound traffic for the first road 104 to moving in the left lane 108 for northbound traffic for the first road 104.

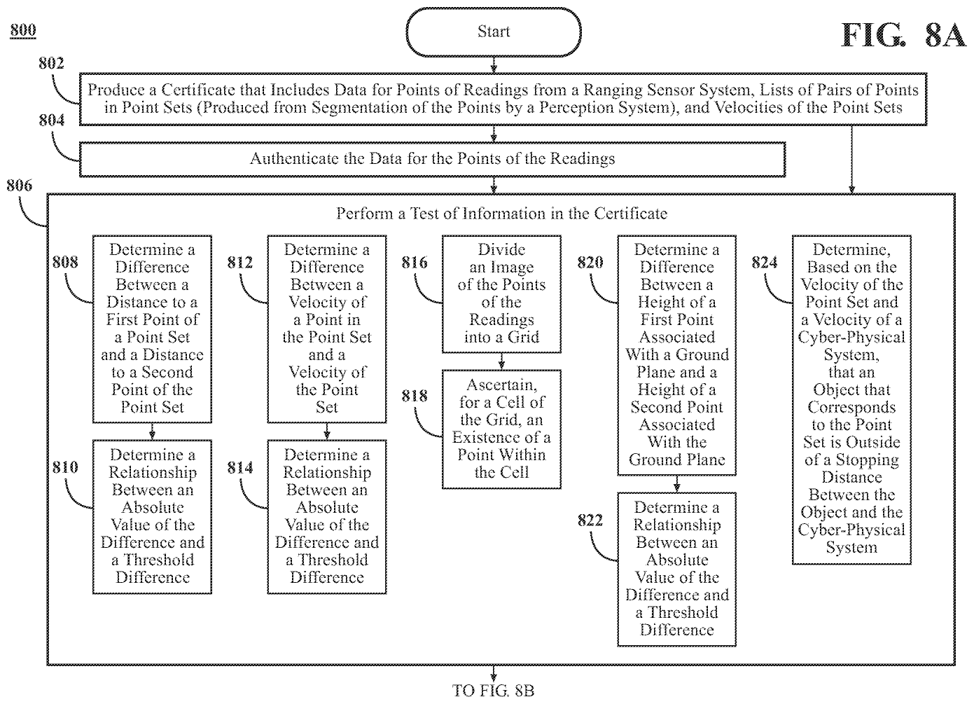

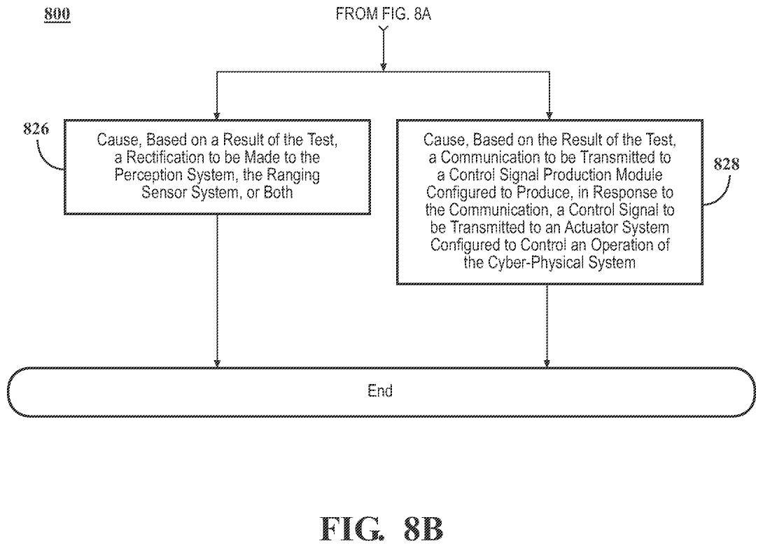

FIGS. 8A and 8B are a flow diagram that illustrates an example of a method 800 that is associated with verifying the object recognition determination produced by the perception system 302, of the cyber-physical system 304, from the data received from the ranging sensor system 306 of the cyber-physical system 304, according to the disclosed technologies. The method 800 is described from the perspective of the system 300 illustrated in FIG. 3. Although the method 800 is described in combination with the system 300 illustrated in FIG. 3, one of skill in the art understands, in light of the description herein, that the method 800 is not limited to being implemented by the system 300 illustrated in FIG. 3. Rather, the system 300 illustrated in FIG. 3 is an example of a system that may be used to implement the method 800. Additionally, although the method 800 is illustrated as a generally serial process, various aspects of the method 800 may be able to be executed in parallel.

For example, the cyber-physical system 304 can include a medical monitoring system, an electrical grid monitoring system, an industrial control system, a robotics system, or the like. For example, the robotics system can include an autonomous vehicle.

For example, the ranging sensor system 306 can include one or more of a lidar device, a radar device, an ultrasonic ranging device, an infrared ranging device, or the like.

In FIG. 8A, in the method 800, at an operation 802, for example, the controller subsystem module 312 can produce a certificate. The certificate can include, for example, data for points of readings from the ranging sensor system 306. The points can have been segmented, by the perception system 302, into point sets that correspond to objects in an environment of the cyber-physical system 304. The certificate can also include, for each point set, for example: (1) lists of pairs of points in a point set and (2) a velocity of the point set. For each point set, a corresponding list of pairs of points in the point set can be referred to as a traversal.

Data for a point, of the points of the readings, can include a location of the point.

Additionally, for example, the data for the point can include a velocity of the point. For example, the ranging sensor system 306 can include a Doppler device configured to determine the velocity of the point. Additionally or alternatively, for example, the perception system 302 can be configured to calculate the velocity of the point.

As described above, the points of the readings can be segmented, by the perception system 302, into the point sets that correspond to the objects in the environment of the cyber-physical system 304. Because each point set can correspond to an object, a set of point sets produced by the perception system 302 can be an object recognition determination produced by the perception system 302. For example, the perception system 302 can be configured to execute a function having as arguments the data for the points of the readings. The function can segment the points into the point sets. Additionally or alternatively, for example, the perception system 302 can be configured to receive, from the image sensor system 318, an image of the environment of the cyber-physical system 304. For example, the image sensor system 318 can include one or more of a camera, an ultrasonic imaging device, an infrared imaging device, or the like. For example, the camera can include one or more of a color camera, a stereoscopic camera, a video camera, a digital video camera, or the like. The perception system 302 can be configured to process the data for the points of the readings and the image to segment the points into the point sets.

Additionally, for example, the data for the point can include an identification of the point set in which the point, following segmentation of the points of the readings by the perception system 302, is an element.

At an operation 804, for example, the runtime monitoring module 314 can authenticate the data for the points of the readings. For example, the data for the points can include a digital signature. For example, the runtime monitoring module 314 can use the digital signature to verify an authenticity of the data for the points. For example, the ranging sensor system 306 can be configured to produce the digital signature. For example, the range sensor system 306 can be a secure ranging sensor system. Additionally or alternatively, for example, the encryption system 320 can be configured to: (1) receive, from the ranging sensor system 306, the data for the points, (2) produce the digital signature, and (3) transmit, to the perception system 302, the data for the points with the digital signature. Additionally or alternatively, for example, the runtime monitoring module 314 can cause communications to be exchanged between the runtime monitoring module 314 and the ranging sensor system 306 to verify an authenticity of the data for the points.

At an operation 806, for example, the runtime monitoring module 314 can perform a test of information in the certificate.

In a first implementation of the test, at an operation 808, for example, the runtime monitoring module 314 can determine a difference between: (1) a distance between a first point, of a pair of points from a list of the pairs of points in the point set, and the cyber-physical system 304 and (2) a distance between a second point, of the pair of points from the list of pairs of points in the point set, and the cyber-physical system 304.

At an operation 810, for example, the runtime monitoring module 314 can determine a relationship between an absolute value of the difference and a threshold difference.

Additionally or alternatively, in a second implementation of the test, at an operation 812, for example, the runtime monitoring module 314 can determine a difference between: (1) a velocity of a point in the point set and (2) the velocity of the point set.

At an operation 814, for example, the runtime monitoring module 314 can determine a relationship between an absolute value of the difference and a threshold difference.

Additionally or alternatively, at an operation 816, for example, the runtime monitoring module 314 can divide an image of the points of the readings into a grid.

Additionally or alternatively, in a third implementation of the test, at an operation 818, for example, the runtime monitoring module 314 can ascertain, for a cell of the grid, an existence of a point within the cell.

Additionally or alternatively, for example, the certificate can include a label that identifies a point, of the points of the readings, with respect to being associated with a ground plane. For example, the label that identifies the point can include a first label and a second label. For example: (1) the first label can identify the point with respect to being associated with a road surface and (2) the second label can identify the point with respect to being associated with a sidewalk. For example, the perception system 302 can be configured to: (1) identify the point as being associated with the ground plane and (2) add, to the data for the point, the label.

Additionally or alternatively, in a fourth implementation of the test, at an operation 820, for example, the runtime monitoring module 314 can determine a difference between: (1) a height of a first point of a set of points associated with the ground plane and (2) a height of a second point of the set of points associated with the ground plane.

At an operation 822, for example, the runtime monitoring module 314 can determine a relationship between an absolute value of the difference and a threshold difference.

Additionally or alternatively, in a fifth implementation of the test, at an operation 824, for example, the runtime monitoring module 314 can determine, based on the velocity of the point set and a velocity of the cyber-physical system 304, that an object that corresponds to the point set is outside of a stopping distance between the object and the cyber-physical system 304.

In FIG. 8B, in the method 800, at an operation 826, for example, the runtime monitoring module 314 can cause, based on a result of the test, a rectification to be made to the perception system 302, the ranging sensor system 306, or both. For example, the rectification can include an adjustment to an operation of the perception system 302, the ranging sensor system 306, or both.

Additionally or alternatively, at an operation 828, for example, the runtime monitoring module 314 can cause, based on the result of the test, a communication to be transmitted to the control signal production module 322 configured to produce, in response to the communication, a control signal to be transmitted to the actuator system 324 configured to control an operation of the cyber-physical system 304. For example, the communication can include information about the result of the test. For example, the information about the result of the test can include an indication that an output of the perception system 302, the ranging sensor system 306, or both is unreliable.

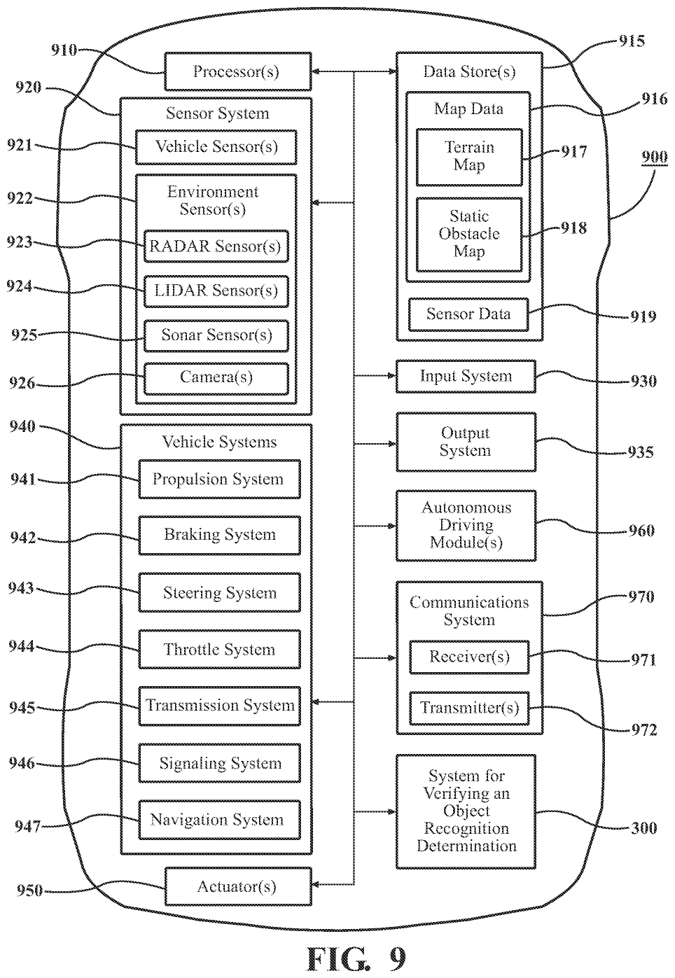

FIG. 9 includes a block diagram that illustrates an example of elements disposed on a vehicle 900, according to the disclosed technologies. As used herein, a “vehicle” can be any form of powered transport. In one or more implementations, the vehicle 900 can be an automobile. While arrangements described herein are with respect to automobiles, one of skill in the art understands, in light of the description herein, that embodiments are not limited to automobiles.

In some embodiments, the vehicle 900 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 900 is performed according to inputs received from a user (e.g., human driver). In one or more arrangements, the vehicle 900 can be a conventional vehicle that is configured to operate in only a manual mode.

In one or more embodiments, the vehicle 900 can be an automated vehicle. As used herein, “automated vehicle” can refer to a vehicle that operates in an automated mode. As used herein, “automated mode” can refer to navigating and/or maneuvering the vehicle 900 along a travel route using one or more computing systems to control the vehicle 900 with minimal or no input from a human driver. In one or more embodiments, the vehicle 900 can be highly automated or completely automated. In one embodiment, the vehicle 900 can be configured with one or more semi-automated operational modes in which one or more computing systems perform a portion of the navigation and/or maneuvering of the vehicle along a travel route, and a vehicle operator (i.e., driver) provides inputs to the vehicle 900 to perform a portion of the navigation and/or maneuvering of the vehicle 900 along a travel route.

For example, Standard J3016, Taxonomy and Definitions for Terms Related to Driving Automation Systems for On-Road Motor Vehicles, issued by the Society of Automotive Engineers (SAE) International on Jan. 16, 2014, and most recently revised on Jun. 15, 2018, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 900 can include various elements. The vehicle 900 can have any combination of the various elements illustrated in FIG. 9. In various embodiments, it may not be necessary for the vehicle 900 to include all of the elements illustrated in FIG. 9. Furthermore, the vehicle 900 can have elements in addition to those illustrated in FIG. 9. While the various elements are illustrated in FIG. 9 as being located within the vehicle 900, one or more of these elements can be located external to the vehicle 900. Furthermore, the elements illustrated may be physically separated by large distances. For example, as described, one or more components of the disclosed system can be implemented within the vehicle 900 while other components of the system can be implemented within a cloud-computing environment, as described below. For example, the elements can include one or more processors 910, one or more data stores 915, a sensor system 920, an input system 930, an output system 935, vehicle systems 940, one or more actuators 950, one or more automated driving modules 960, a communications system 970, and the system 300 for verifying an object recognition determination

In one or more arrangements, the one or more processors 910 can be a main processor of the vehicle 900. For example, the one or more processors 910 can be an electronic control unit (ECU). For example, functions and/or operations of the processor 308 (illustrated in FIG. 3) can be realized by the one or more processors 910.

The one or more data stores 915 can store, for example, one or more types of data. For example, functions and/or operations of the memory 310, the data store 316 (illustrated in FIG. 3), or any combination thereof can be realized by the one or more data stores 915. The one or more data stores 915 can include volatile memory and/or non-volatile memory. Examples of suitable memory for the one or more data stores 915 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 915 can be a component of the one or more processors 910. Additionally or alternatively, the one or more data stores 915 can be operatively connected to the one or more processors 910 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation.

In one or more arrangements, the one or more data stores 915 can store map data 916. The map data 916 can include maps of one or more geographic areas. In some instances, the map data 916 can include information or data on roads, traffic control devices, road markings, structures, features, and/or landmarks in the one or more geographic areas. The map data 916 can be in any suitable form. In some instances, the map data 916 can include aerial views of an area. In some instances, the map data 916 can include ground views of an area, including 360-degree ground views. The map data 916 can include measurements, dimensions, distances, and/or information for one or more items included in the map data 916 and/or relative to other items included in the map data 916. The map data 916 can include a digital map with information about road geometry. The map data 916 can be high quality and/or highly detailed.

In one or more arrangements, the map data 916 can include one or more terrain maps 917. The one or more terrain maps 917 can include information about the ground, terrain, roads, surfaces, and/or other features of one or more geographic areas. The one or more terrain maps 917 can include elevation data of the one or more geographic areas. The map data 916 can be high quality and/or highly detailed. The one or more terrain maps 917 can define one or more ground surfaces, which can include paved roads, unpaved roads, land, and other things that define a ground surface.

In one or more arrangements, the map data 916 can include one or more static obstacle maps 918. The one or more static obstacle maps 918 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 918 can have location data, size data, dimension data, material data, and/or other data associated with them. The one or more static obstacle maps 918 can include measurements, dimensions, distances, and/or information for one or more static obstacles. The one or more static obstacle maps 918 can be high quality and/or highly detailed. The one or more static obstacle maps 918 can be updated to reflect changes within a mapped area.

In one or more arrangements, the one or more data stores 915 can store sensor data 919. As used herein, “sensor data” can refer to any information about the sensors with which the vehicle 900 can be equipped including the capabilities of and other information about such sensors. The sensor data 919 can relate to one or more sensors of the sensor system 920. For example, in one or more arrangements, the sensor data 919 can include information about one or more lidar sensors 924 of the sensor system 920.

In some arrangements, at least a portion of the map data 916 and/or the sensor data 919 can be located in one or more data stores 915 that are located onboard the vehicle 900. Alternatively or additionally, at least a portion of the map data 916 and/or the sensor data 919 can be located in one or more data stores 915 that are located remotely from the vehicle 900.

The sensor system 920 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 920 includes a plurality of sensors, the sensors can work independently from each other. Alternatively, two or more of the sensors can work in combination with each other. In such a case, the two or more sensors can form a sensor network. The sensor system 920 and/or the one or more sensors can be operatively connected to the one or more processors 910, the one or more data stores 915, and/or another element of the vehicle 900 (including any of the elements illustrated in FIG. 9). The sensor system 920 can acquire data of at least a portion of the external environment of the vehicle 900 (e.g., nearby vehicles). The sensor system 920 can include any suitable type of sensor. Various examples of different types of sensors are described herein. However, one of skill in the art understands that the embodiments are not limited to the particular sensors described herein.

The sensor system 920 can include one or more vehicle sensors 921. The one or more vehicle sensors 921 can detect, determine, and/or sense information about the vehicle 900 itself. In one or more arrangements, the one or more vehicle sensors 921 can be configured to detect and/or sense position and orientation changes of the vehicle 900 such as, for example, based on inertial acceleration. In one or more arrangements, the one or more vehicle sensors 921 can include one or more accelerometers, one or more gyroscopes, an inertial measurement unit (IMU), a dead-reckoning system, a global navigation satellite system (GNSS), a global positioning system (GPS), a navigation system 947, and/or other suitable sensors. The one or more vehicle sensors 921 can be configured to detect and/or sense one or more characteristics of the vehicle 900. In one or more arrangements, the one or more vehicle sensors 921 can include a speedometer to determine a current speed of the vehicle 900.

Alternatively or additionally, the sensor system 920 can include one or more environment sensors 922 configured to acquire and/or sense driving environment data. As used herein, “driving environment data” can include data or information about the external environment in which a vehicle is located or one or more portions thereof. For example, the one or more environment sensors 922 can be configured to detect, quantify, and/or sense obstacles in at least a portion of the external environment of the vehicle 900 and/or information/data about such obstacles. Such obstacles may be stationary objects and/or dynamic objects. The one or more environment sensors 922 can be configured to detect, measure, quantify, and/or sense other things in the external environment of the vehicle 900 such as, for example, lane markers, signs, traffic lights, traffic signs, lane lines, crosswalks, curbs proximate the vehicle 900, off-road objects, etc. For example, functions and/or operations of the sensor system 204, the ranging sensor system 212, the image sensor system 214, the lidar device 224, the radar device 226, the ultrasonic device 228, the camera 232 (illustrated in FIG. 2), ranging sensor system 306, the image sensor system 318 (illustrated in FIG. 3), or any combination thereof can be realized by the one or more environment sensors 922.

Various examples of sensors of the sensor system 920 are described herein. The example sensors may be part of the one or more vehicle sensors 921 and/or the one or more environment sensors 922. However, one of skill in the art understands that the embodiments are not limited to the particular sensors described.

In one or more arrangements, the one or more environment sensors 922 can include one or more radar sensors 923, one or more lidar sensors 924, one or more sonar sensors 925, and/or one more cameras 926. In one or more arrangements, the one or more cameras 926 can be one or more high dynamic range (HDR) cameras or one or more infrared (IR) cameras. For example, the one or more cameras 926 can be used to record a reality of a state of an item of information that can appear in the digital map.

The input system 930 can include any device, component, system, element, arrangement, or groups thereof that enable information/data to be entered into a machine. The input system 930 can receive an input from a vehicle passenger (e.g., a driver or a passenger). The output system 935 can include any device, component, system, element, arrangement, or groups thereof that enable information/data to be presented to a vehicle passenger (e.g., a driver or a passenger).

Various examples of the one or more vehicle systems 940 are illustrated in FIG. 9. However, one of skill in the art understands that the vehicle 900 can include more, fewer, or different vehicle systems. Although particular vehicle systems can be separately defined, each or any of the systems or portions thereof may be otherwise combined or segregated via hardware and/or software within the vehicle 900. For example, the one or more vehicle systems 940 can include a propulsion system 941, a braking system 942, a steering system 943, a throttle system 944, a transmission system 945, a signaling system 946, and/or the navigation system 947. Each of these systems can include one or more devices, components, and/or a combination thereof, now known or later developed.

The navigation system 947 can include one or more devices, applications, and/or combinations thereof, now known or later developed, configured to determine the geographic location of the vehicle 900 and/or to determine a travel route for the vehicle 900. The navigation system 947 can include one or more mapping applications to determine a travel route for the vehicle 900. The navigation system 947 can include a global positioning system, a local positioning system, a geolocation system, and/or a combination thereof.

The one or more actuators 950 can be any element or combination of elements operable to modify, adjust, and/or alter one or more of the vehicle systems 940 or components thereof responsive to receiving signals or other inputs from the one or more processors 910 and/or the one or more automated driving modules 960. Any suitable actuator can be used. For example, the one or more actuators 950 can include motors, pneumatic actuators, hydraulic pistons, relays, solenoids, and/or piezoelectric actuators. For example, functions and/or operations of the actuator system 210, the wheel steering actuators 234, the brake actuators 236, the clutch actuator 238, the throttle position actuator 240, the current control actuator 242 (illustrated in FIG. 2), the actuator system 324 (illustrated in FIG. 3), or any combination thereof can be realized by the one or more actuators 950.

The one or more processors 910 and/or the one or more automated driving modules 960 can be operatively connected to communicate with the various vehicle systems 940 and/or individual components thereof. For example, the one or more processors 910 and/or the one or more automated driving modules 960 can be in communication to send and/or receive information from the various vehicle systems 940 to control the movement, speed, maneuvering, heading, direction, etc. of the vehicle 900. The one or more processors 910 and/or the one or more automated driving modules 960 may control some or all of these vehicle systems 940 and, thus, may be partially or fully automated.

The one or more processors 910 and/or the one or more automated driving modules 960 may be operable to control the navigation and/or maneuvering of the vehicle 900 by controlling one or more of the vehicle systems 940 and/or components thereof. For example, when operating in an automated mode, the one or more processors 910 and/or the one or more automated driving modules 960 can control the direction and/or speed of the vehicle 900. The one or more processors 910 and/or the one or more automated driving modules 960 can cause the vehicle 900 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 970 can include one or more receivers 971 and/or one or more transmitters 972. The communications system 970 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 970 can include “connected car” technology. “Connected car” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies.

The vehicle 900 can include one or more modules, at least some of which are described herein. The modules can be implemented as computer-readable program code that, when executed by the one or more processors 910, implement one or more of the various processes described herein. One or more of the modules can be a component of the one or more processors 910. Alternatively or additionally, one or more of the modules can be executed on and/or distributed among other processing systems to which the one or more processors 910 can be operatively connected. The modules can include instructions (e.g., program logic) executable by the one or more processors 910. Alternatively or additionally, the one or more data store 915 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 900 can include one or more automated driving modules 960. The one or more automated driving modules 960 can be configured to receive data from the sensor system 920 and/or any other type of system capable of capturing information relating to the vehicle 900 and/or the external environment of the vehicle 900. In one or more arrangements, the one or more automated driving modules 960 can use such data to generate one or more driving scene models. The one or more automated driving modules 960 can determine position and velocity of the vehicle 900. The one or more automated driving modules 960 can determine the location of obstacles, obstacles, or other environmental features including traffic signs, trees, shrubs, neighboring vehicles, pedestrians, etc.

The one or more automated driving modules 960 can be configured to receive and/or determine location information for obstacles within the external environment of the vehicle 900 for use by the one or more processors 910 and/or one or more of the modules described herein to estimate position and orientation of the vehicle 900, vehicle position in global coordinates based on signals from a plurality of satellites, or any other data and/or signals that could be used to determine the current state of the vehicle 900 or determine the position of the vehicle 900 with respect to its environment for use in either creating a map or determining the position of the vehicle 900 in respect to map data.

The one or more automated driving modules 960 can be configured to determine one or more travel paths, current automated driving maneuvers for the vehicle 900, future automated driving maneuvers and/or modifications to current automated driving maneuvers based on data acquired by the sensor system 920, driving scene models, and/or data from any other suitable source such as determinations from the sensor data 919. As used herein, “driving maneuver” can refer to one or more actions that affect the movement of a vehicle. Examples of driving maneuvers include: accelerating, decelerating, braking, turning, moving in a lateral direction of the vehicle 900, changing travel lanes, merging into a travel lane, and/or reversing, just to name a few possibilities. The one or more automated driving modules 960 can be configured to implement determined driving maneuvers. The one or more automated driving modules 960 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 960 can be configured to execute various vehicle functions and/or to transmit data to, receive data from, interact with, and/or control the vehicle 900 or one or more systems thereof (e.g., one or more of vehicle systems 940). For example, functions and/or operations of an automotive navigation system can be realized by the one or more automated driving modules 960.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-4, 5A, 5B, 6, 7, 8A, 8B, and 9, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
a controller subsystem module including instructions that when executed by the processor cause the processor to produce a certificate that includes:
data for points of readings from a ranging sensor system, the points segmented, by a perception system, into point sets that correspond to objects in an environment of a cyber-physical system,
lists of pairs of points in a point set, and
a velocity of the point set; and
a runtime monitoring module including instructions that when executed by the processor cause the processor to:
perform a test of information in the certificate; and
cause, based on a result of the test, at least one of:
a rectification to be made to at least one of the perception system or the ranging sensor system, or
a communication to be transmitted to a control signal production module; and
the control signal production module including instructions that when executed by the processor cause the processor to produce, in response to the communication, a control signal to be transmitted to an actuator system configured to control an operation of the cyber-physical system.

2. The system of claim 1, wherein the cyber-physical system comprises at least one of a medical monitoring system, an electrical grid monitoring system, an industrial control system, or robotics system.

3. The system of claim 2, wherein the robotics system comprises an autonomous vehicle.

4. The system of claim 1, wherein the ranging sensor system comprises at least one of a lidar device, a radar device, an ultrasonic ranging device, or an infrared ranging device.

5. The system of claim 1, wherein the runtime monitoring module further includes instructions that when executed by the processor cause the processor to authenticate the data for the points of the readings.

6. The system of claim 5, wherein:
the data for the points of the readings include a digital signature; and
the instructions to authenticate the data for the points of the readings include instructions to cause the processor to use the digital signature to verify an authenticity of the data for the points of the readings.

7. The system of claim 5, wherein the instructions to authenticate the data for the points of the readings include instructions to cause the processor to cause communications to be exchanged between the runtime monitoring module and the ranging sensor system to verify an authenticity of the data for the points of the readings.

8. The system of claim 1, wherein the test comprises:
determining a difference between:
a distance between a first point, of a pair of points from a list of the pairs of points in the point set, and the cyber-physical system and
a distance between a second point, of the pair of points from the list of pairs of points in the point set, and the cyber-physical system; and
determining a relationship between an absolute value of the difference and a threshold difference.

9. The system of claim 1, wherein the test comprises:
determining a difference between a velocity of a point in the point set and the velocity of the point set; and
determining a relationship between an absolute value of the difference and a threshold difference.

10. The system of claim 1, wherein:
the runtime monitoring module further includes instructions that when executed by the processor cause the processor to divide an image of the points of the readings into a grid; and
the test comprises ascertaining, for a cell of the grid, an existence of a point within the cell.

11. The system of claim 1, wherein the certificate includes a label that identifies a point, of the points of the readings, with respect to being associated with a ground plane.

12. The system of claim 11, wherein the test comprises:
determining a difference between:
a height of a first point of a set of points associated with the ground plane; and
a height of a second point of the set of points associated with the ground plane; and
determining a relationship between an absolute value of the difference and a threshold difference.

13. The system of claim 1, wherein the test comprises determining, based on the velocity of the point set and a velocity of the cyber-physical system, that an object that corresponds to the point set is outside of a stopping distance between the object and the cyber-physical system.

14. The system of claim 1, wherein the rectification comprises an adjustment to an operation of the at least one of the perception system or the ranging sensor system.

15. The system of claim 1, wherein the communication includes information about the result of the test.

16. The system of claim 15, wherein the information about the result of the test includes an indication that an output of the at least one of the perception system or the ranging sensor system is unreliable.

17. A method, comprising:
producing, by a processor, a certificate that includes:
data for points of readings from a ranging sensor system, the points segmented, by a perception system, into point sets that correspond to objects in an environment of a cyber-physical system,
lists of pairs of points in a point set, and
a velocity of the point set;
performing, by the processor, a test of information in the certificate; and
causing, by the processor and based on a result of the test, at least one of:
a rectification to be made to at least one of the perception system or the ranging sensor system, or
a communication to be transmitted to a control signal production module configured to produce, in response to the communication, a control signal to be transmitted to an actuator system configured to control an operation of the cyber-physical system.

18. The method of claim 17, wherein data for a point, of the points of the readings, comprise a location of the point.

19. The method of claim 18, wherein the data for the point further comprise a velocity of the point.

20. A non-transitory computer-readable medium for verifying an object recognition determination produced by a perception system from data received from a ranging sensor system, the non-transitory computer-readable medium including instructions that when executed by one or more processors cause the one or more processors to:
produce a certificate that includes:
data for points of readings from the ranging sensor system, the points segmented, by the perception system, into point sets that correspond to objects in an environment of a cyber-physical system,
lists of pairs of points in a point set, and
a velocity of the point set;
perform a test of information in the certificate; and
cause, based on a result of the test, at least one of:
a rectification to be made to at least one of the perception system or the ranging sensor system, or
a communication to be transmitted to a control signal production module configured to produce, in response to the communication, a control signal to be transmitted to an actuator system configured to control an operation of the cyber-physical system.
